(19) United States
(12) Patent Application Publication
(10) Pub. No.: US 2003/0028802 A1
(43) Pub. Date: Feb. 6, 2003

(54) Asynchronous communication protocol for electronic keys of security locks and systems

(76) Inventor: Jose Agustin Tejedor Ruiz, Vizcaya (ES)

Correspondence Address: Kevin S. Lemack, Nields & Lemack, 176 E. Main Street, Westboro, MA, 01581, US

(21) Appl. No.: 10/207,562

(22) Filed: Jul. 29, 2002

(30) Foreign Application Priority Data
Aug. 3, 2001 (ES) 200101831

(51) Int. Cl. H04J 15/00

(52) U.S. Cl. 713/200; 370/464

(57) ABSTRACT

Asynchronous communication protocol for electronic keys of security locks and systems, characterized by the use of a same and only channel to transmit the time and the data (bits), that single channel has two states: one normal state of rest and another active state when communication occurs and through the use of an active pulse to indicate the start of a bit; using an active pulse to indicate the transmission of a 1 bit, and the use of a resting state for the transmission of a 0 bit; the active pulse consists of the maintenance of the communication channel in an active state during a brief period of time and the use of a resting state which permits the extraction of energy from the communication channel and an active state which does not impede the maintenance of a certain level of energy which is sufficient for the proper functioning of the devices connected to the communication channel.

### FIELD OF THE INVENTION

The present invention refers to an asynchronous communication protocol for electronic keys of security locks and systems; through which the transference of the bits should take place.

### BACKGROUND OF THE INVENTION

The electronic locking systems based on electronic contact keys need to exchange data between them. The data are composed of bits which should be sent following a previously arranged standard or protocol between the two devices.

To exchange data between electronic devices two types of protocols are frequently used: synchronous and asynchronous.

Synchronous protocols use a time signal to determine the moment in which each bit is sent.

The synchronizing time can be an external signal sent in addition to the data channel. This system has the disadvantage of requiring an independent channel to transmit this time between the lock and the electronic key, which is not desirable due to the cost of the same and the limitation of space which exists with these types of devices.

The syncronizing time can be a signal generated internally within each device. The device clocks should remain synchronized during the transmission of the data. This system has the disadvantage of the cost of the clocks mentioned, which should be very expensive due to the fact that it is necessary to have a perfect synchronization during the transmission of all of the bits.

Asynchronous protocols do not require a time signal to determine the cadence of transmission of the bits. These protocols transmit the bits in groups of bytes and begin each byte with a mark indicating the beginning of a byte. Upon receiving this mark the two devices synchronize their internal clocks and send the bits which compose the byte in a synchronous manner according to the cadence of said clocks. The advantage of this system is that the synchronizing clocks of both devices only need to remain synchronized during the time of transmission of a byte.

Electronic keys are autonomous systems without batteries, which must receive some type of energy in order to function correctly. Frequently a cable is used for the communication of data, according to the previously mentioned asynchronous protocol, and another is used for powering the electronic key, which is not desirable given the existing space limitations in the electronic keys.

It is desirable to have a system in which the key extracts energy from the same communication channel in order to be able to function correctly, without the need for an additional power channel.

### SUMMARY OF THE INVENTION

The invention consists of an asynchronous communication protocol for electronic keys of security locks and systems which is characterized by the use of a single and only channel for the transmission of the time and the data (bits). This single channel has two states: one normal state of rest and another active state when communication occurs and through the use of an active pulse to indicate the start of a bit; using an active pulse to indicate the transmission of a 1 bit, and the use of a resting state for the transmission of a 0 bit; the active pulse consists of the maintenance of the communication channel in an active state during a brief period of time and the use of a resting state which permits the extraction of energy from the communication channel and an active state which does not impede the maintenance of a certain level of energy which is sufficient for the proper functioning of the devices connected to the communication channel.

In addition, during the active state, the power is maintained by a capacitor which maintains the voltage during the time that the active pulse lasts.

The advantages of the present invention are:

The protocol does not require the synchronization of any internal clocks in the devices which interact during the communication,

This protocol does not require an additional channel to provide an external time signal,

The protocol allows energy to be supplied to one of the devices through the same communication channel and simultaneously during the communication.

### BRIEF DESCRIPTION OF THE DRAWINGS

To better understand the nature of the present invention, in the attached drawing we present a recommended industrial application, which has the character of a simply illustrative and not limiting example.

FIG. 1 shows the emitting device (E) connected to a receiver (R) by a single communication cable (C).

FIG. 2 shows the beginning of the bits of an active pulse.

### DESCRIPTION OF A PREFERRED EMBODIMENT

The present invention describes an asynchronous communication protocol for the transmission of bits which permits the transmission and extraction of energy using the same communication channel.

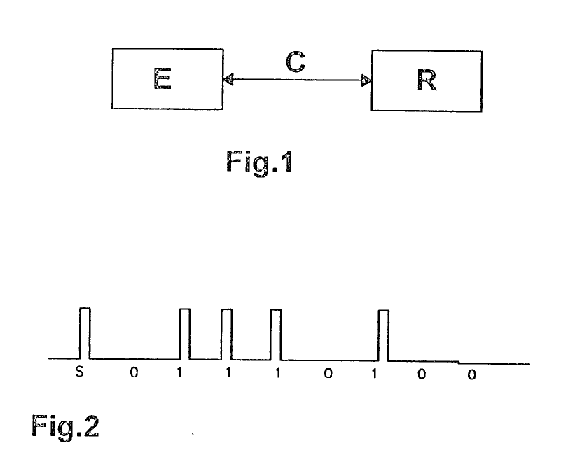

There are two electronic devices (E, R) connected by a single communication channel C (FIG. 1).

The communication channel is capable of maintaining two logical levels indicated as resting and active. These states can be associated with any physical state, for example two levels of voltage, two levels of current, etc.

While the two are not in communication with each other, the emitter (E) and the receptor (R) maintain the communication channel C in a resting state.

When the emitter wants to send a byte, the emitter forces the channel to the active level during a brief period of time designated the active pulse. This active pulse indicates the beginning of a byte (FIG. 2).

Through the transmission of the active pulse at the beginning of a byte the bits which compose the byte are sent with a predetermined time cadence (bit time);

If the bit to be sent is a 0, the emitter maintains the channel in a resting state during a certain period of time (bit time).

If the bit to be sent is a 1, the emitter sends an active pulse during the bit time period.

The asynchronous character of this system lies in the fact that the following byte can be sent at any moment once the transmission of the previous byte has finished.

The bit time can be fixed, previously arranged between the two devices, or can be automatically calculated by measuring the duration of the bit times of a predetermined sequence of bytes sent before each message.

The proposed system permits energy to be supplied simultaneously to the communication. In this case two restrictions are imposed on the proposed system:

The logical resting state of the communication channel (C) must be associated with a physical state capable of supplying energy to an electrical system. For example, this resting state can be associated with a voltage of 5 volts, so that the receiving device can extract this voltage and use it as a supply voltage.

The logical active state of the communication channel (C) must be associated with a physical state such that the transitions between the resting state and active state do not impede the supply of energy to the receiving device. For example, this active state can be associated with a voltage of 0 volts, and the active pulse fixed in a few microseconds, so that during this time in which the channel remains in the active state, the receiving device cannot extract energy from the channel. Nevertheless, this time is sufficiently small to be able to extract the energy from a means internal to the receptor, for example a capacitor, battery, etc. which is charged with energy during the resting states and discharged during the active states.

What is claimed is:

1. An asynchronous communication protocol for electronic keys of security locks and systems, characterized by the use of a same and only channel to transmit the time and the data (bits), this single channel has two states; one normal resting state and another active state when communication takes place and throught the use of an active pulse to indicate the beginning of a bit; using an active pulse to indicate the transmission of a 1 bit and using a resting state for the transmission of a 0 bit; the active pulse consists of the maintenance of the communication channel in an active state during a brief period of time and the use of a resting state which permits the extraction of energy from the communication channel and an active state which does not impede the maintenance of a certain level of energy which is sufficient for the proper functioning of the two devices connected to the communication channel.

2. The asynchronous communication protocol for electronic keys of security locks and systems, according to claim 1, further characterized in that during the active state the maintenance of the energy level is achieved by a capacitor which maintains the voltage during the time which the active pulse lasts.
